(19) United States
(12) Patent Application Publication
(10) Pub. No.: US 2020/0256481 A1
(43) Pub. Date: Aug. 13, 2020

(54) SELF-CLEANING VALVE

(71) Applicant: SAUDI ARABIAN OIL COMPANY, Dhahran (SA)

(72) Inventor: Ali Taher AL-QUDAIHI, Dhahran (SA)

(73) Assignee: SAUDI ARABIAN OIL COMPANY, Dhahran (SA)

(21) Appl. No.: 15/774,354

(22) PCT Filed: Nov. 7, 2016
(86) PCT No.: PCT/SA2016/050001

§ 371 Date: May 8, 2018

(30) Foreign Application Priority Data
Nov. 8, 2015 (SA) 115370067

(51) Int. Cl. F16K 41/04; F16K 3/24; F16K 31/60

(52) U.S. Cl. CPC F16K 41/04; F16K 31/60; F16K 3/243

(57) ABSTRACT

In at least one embodiment, the present invention provides a self-cleaning valve having a valve body defining an internal cavity and having a first end, a second end, a perimeter wall extending between the first end and a second end, an inlet fluidly communicating with the internal cavity, an outlet fluidly communicating with the internal cavity and a stem bore fluidly communicating with the internal cavity, a valve stem having a first end and second end and operable for linear movement between a first open position and a second closed position, the valve stem received in the stem bore, the first end of the valve stem having a plug, the plug adapted to seal the inlet of the valve body when in the second closed position.

### FIELD

The present invention relates to equipment for use in connection with mechanical piping systems used in industrial applications. More specifically, the preset invention relates to a self-cleaning valve for use in drain and vent applications in industrial piping systems.

### BACKGROUND

Gate valves are commonly used in mechanical piping systems for regulating flow. More specifically, given the fluid dynamics incurred during the actuation of a gate valve, these types of valves are particularly well suited for use as a shutoff or isolation valve as gate valves can introduce undesirable cavitation, vibration and non-laminar flow when used to regulate fluid flow in a pipe by partially activating the gate valve. In other words, gate valves function best when either employed in an fully open or closed position.

Gate valves have a gate that is deployed from an open position to a closed position within the valve body by way of a stem. Typically, the stem is activated by way of a hand wheel or electronic actuator. The stem is surrounded by mechanical packing which is adapted to seal the interface between the valve body and the stem to eliminate fluid leak. Moreover, the gate typically seats in a groove (provided in the valve body) when in the closed position. Finally, gate valves may have flanged ends for connecting the respective inlets and outlets to the overall piping system.

However, standard gate valves present a host of challenges in industrial use, particularly when used in drain and vent applications. At the outset, it is readily understood that the conditions in which industrial valves are operated can be incredibly harsh. As such, over time mechanical packing can harden and become prone to leaking fluid between the valve body and the stem. Moreover, sludge can often buildup in the groove necessitating regular cleaning in order to provide a sufficient seal in the closed position. Given that drains and vents are “root” valves in a typical industrial system, maintenance of these types of valves often require full system shutdown, which creates both economic and productivity costs and also can expose operators and maintenance staff to potential injury.

Accordingly, there is need for a valve that is well suited for use in drain and vent applications. Specifically, there is need for a drain valve that is easy to clean, robust and which avoids the challenges presented by the use of mechanical packing around the valve stem/valve body interface.

### BRIEF SUMMARY

In at least one embodiment, it is contemplated that the present invention can provide an easy to clean, robust and resilient self-cleaning valve which avoids the challenges presented by the use of mechanical packing around the valve stem/valve body interface.

More specifically, in at least one embodiment. In at least one embodiment, the present invention provides a self-cleaning valve having a valve body defining an internal cavity and having a first end, a second end, a perimeter wall extending between the first end and a second end, an inlet fluidly communicating with the internal cavity, an outlet fluidly communicating with the internal cavity and a stem bore fluidly communicating with the internal cavity, a valve stem having a first end and second end and operable for linear movement between a first open position and a second closed position, the valve stem received in the stem bore, the first end of the valve stem having a plug, the plug adapted to seal the inlet of the valve body when in the second closed position.

### BRIEF DESCRIPTION OF THE DRAWINGS

The present invention will be better understood in connection with the following drawings in which:

FIG. 1 is an isometric view of a self-cleaning valve in accordance with at least one embodiment of the present invention; and

FIG. 2 is an exploded view of a self-cleaning valve in accordance with at least one embodiment of the present invention.

### DETAILED DESCRIPTION OF THE EMBODIMENTS

It is contemplated that the present invention can provide an easy to clean, robust and resilient self-cleaning valve which avoids the challenges presented by the use of mechanical packing around the valve stem/valve body interface.

As will be readily understood by the skilled person, it is contemplated that the all components discussed herein can be manufactured of any suitable material, by any suitable process and to any suitable dimensions as required by the specific end-user application of the present invention. Further, it is contemplated that the apparatuses discussed herein can be formed of separate components suitably joined together, or alternatively can be formed of single, unitary components, as will be readily understood by the skilled person.

In at least one embodiment it is contemplated that self-cleaning valve has a valve body that operably receives a valve stem. It is contemplated that the valve body can take any suitable shape including cylindrical and prismatic shapes depending of the needs of end-user application. The valve body accordingly has an outer perimeter surface that can take any number of shapes and an internal chamber that can take any number of suitable shapes, as will be readily understood by the skilled person.

The valve body further includes an inlet, an outlet and a stem bore for operably receiving the valve stem. It is contemplated that the inlet and outlet can be adapted to mate with any suitable piping system, and as such the outlet and the inlet can be, for example, threaded or flanged in order to be mechanically connected to the overall piping system. In at least one embodiment, the stem bore is located at the first end of the valve body, however other arrangements are also contemplated. As will be readily appreciated by the skilled person, it is contemplated that the self-cleaning valve can be connected to a piping system by any suitable means, including but not limited to mechanical connection or welding, among other suitable arrangements.

In at least one embodiment, the valve stem has a first end and a second end. In at least one embodiment, the second end further includes a plug that can seal the inlet of the valve body when the valve stem is in a second, closed position as will be discussed in further detail below. It is contemplated that the plug can take any suitable number of shapes provided that the inlet of the valve body can be fully sealed in the second, closed position, including, but not limited to, frustoconical, bulbous, spherical, ovoid and cylindrically disk-shaped, among any other suitable shape as required by the particular needs of the end-user application of the present invention.

In some embodiments, the valve stem comprises at least two sections of different diameters that are joined together at a shoulder on the valve stem. It is contemplated that in these embodiments the shoulder can abut the internal surface of the internal cavity of the valve body adjacent to the stem bore in order to positionally orient the valve stem relative to the valve body and also to provide a degree of sealing engagement between the valve stem and the valve body.

In some embodiments it is contemplated that the valve stem can be at least partially threaded and can cooperate with an analogously threaded gland follower, bonnet or stem riser. In these embodiments, it is contemplated that the threaded gland follower, bonner or stem riser is fixed to the first end of the valve body and has a bore that is aligned with the stem bore of the valve body. In this way, as the valve stem is rotated it will simultaneously be translated linearly along the longitudinal axis of the valve body, as will be discussed in further detail below. In some embodiments, it is contemplated that the first end of the valve stem can further include a hand wheel or an electronic actuator, among any other suitable arrangements, in order to assist with the rotational actuation of the valve stem.

In some embodiments, it is contemplated that the self-cleaning valve further includes a bonnet that is fixed to the first end of the valve body and which has a bore that is aligned with the stem bore of the valve body. It is contemplated that the bonnet can sealingly engage the interface between the valve stem and the stem bore of the valve body in order to prevent fluid leakage, as will be readily understood by the skilled person. In some embodiments it si contemplated that the bonnet further includes a stem riser that can have a bore (that may or may not be threaded) that aligns with the stem bore of the valve body and provides lateral support to the valve stem during operation.

In some embodiments, it is contemplated that the valve body further includes an internal diffuser mechanism, which cooperates with the valve body within the internal cavity of the valve body. More specifically, the internal diffuser has a bore that aligns with the stem bore when assembled in order to operably receive the valve stem and further has an inlet (that in these embodiments functions as the inlet for the entire valve body) and at least one outlet. In at least one embodiment the internal diffuser mechanism is a hollow, cylindrical component that threadedly engages with the valve body and has an inlet that sealing can engage with the plug of the valve stem.

In these embodiments, internal diffuser mechanism has a bore at a first end and an inlet at a second end. Further, the internal diffuser mechanism can have at least one outlet that is radially oriented in the outer cylindrical surface of the internal diffuser mechanism such that when the internal diffuser mechanism is threadedly connected to the valve body the at least one outlet fluidly communicates with the outlet provided on the valve body, as will be readily understood by the skilled person.

Further, in at least one embodiment it is contemplated that the first end of the internal diffuser mechanism has a shoulder provided for mating with the internal surface of the internal chamber of the valve body at a position surrounding and adjacent to the stem bore.

In this way, it is contemplated that the valve stem can be rotationally actuated (by way of, for example, a hand wheel) in order to linearly actuate the present self-cleaning valve from a first, opened position to a second, closed position where the plug seals the inlet of the valve body.

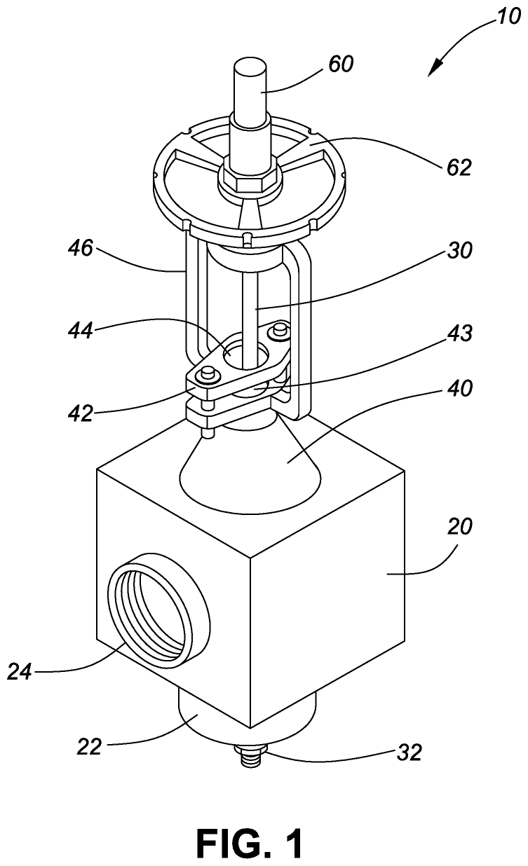

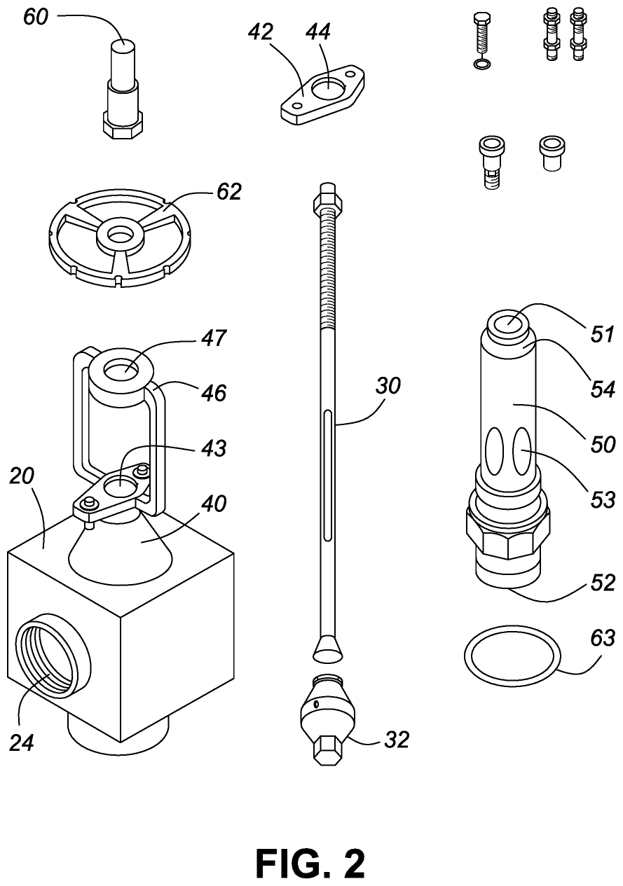

With reference to FIGS. 1 and 2, at least one embodiment of a self-cleaning valve 10 is illustrated having a valve body 20 that cooperates with a valve stem 30. In this embodiment, self-cleaning valve further includes a bonnet 40, an internal diffuser mechanism 50 and a hand wheel 62 with stem cover 60.

In this embodiment, valve body 20 has an inlet 22, and outlet 24. In this embodiment valve body 20 is cubically shaped, however other shapes are fully contemplated as discussed above.

In this embodiment, valve stem 30 has a first end that is threaded and a second end that includes plug 32. In this embodiment, plug 32 is bulbously shaped however other shapes are also contemplated as will be understood by the skilled person. It is contemplated that stem cover 60 can threadingly engage valve stem 30 and further hand wheel 62 can be adapted to mechanically engage stem cover 60.

In this embodiment, valve body 20 includes a bonnet 40. In this embodiment, stem bore 43 is located on bonnet 40 and receives valve stem 30 in sealing engagement in order to prevent fluid leakage between valve body 20 and valve stem 30, however other arrangements are also contemplated as discussed above. Further, in this embodiment a threaded gland follower 42 is provided that is connected to the first end of valve body 20 and has a bore 44 that can be threaded and which aligns with stem bore 43. In this way, as valve stem 30 is rotated it will simultaneously be translated linearly along the longitudinal axis of the valve body 20, as will be readily understood by the skilled person.

In this embodiment, it is contemplated that bonnet 40 can further include a riser 46 with a bore 47 (which also may or may not be threaded to cooperate with valve stem 30) in order to provide additional lateral stiffness for valve stem 30 during operation.

In this embodiment, it is contemplated that valve body 20 threadedly cooperates with an internal diffuser mechanism 50. Internal diffuser mechanism 50 includes an inlet 52 (that aligns with inlet 22) that fluidly communicates with bore 51 and at least one outlet 53 by way of an internal cavity (not shown). In this embodiment, once internal diffuser mechanism 50 is threadedly engaged with valve body 20 the at least one outlet 53 at least partially aligns with outlet 24 in order to allow fluid communication between these two orifices. In this embodiment, a gasket 63 can be provided to provide a fluid seal between valve body 20 and internal diffuser mechanism 50.

Moreover, it is contemplated bore 51 aligns with the stem bore of the valve body 20. In this embodiment, a shoulder 54 is provided to engage an inner surface of valve body 20 in a secure manner.

In this way and as will be understood by the skilled person, as hand wheel 62 is rotated valve stem 30 is simultaneously rotated and linearly translated relative to valve body 20. In this way, valve stem 30 (and plug 32) can be moved from an open, first position (where inlet 52 fluidly communicates with outlet 24, 53) to a second, closed position (where inlet 52 is sealed by plug 32 thereby eliminating fluid communication between inlet 52 and outlet 24,53). Moreover, bonnet 40 is adapted to provide metal-on-metal contact that can effectively and resiliently eliminate fluid leakage between valve body 20 and valve stem 30.

As will be readily appreciated by the skilled person, all components discussed herein can be joined by any suitable manner using any suitable fasteners (including but not limited to bolts or machine screws) and using any suitable sealing apparatuses (including but not limited to flanges, gaskets, bushings, silicone or epoxy) as required by the particular end user application of the present invention.

The present disclosure provides for reference to specific examples. It will be understood that the examples are intended to describe embodiments of the invention and are not intended to limit the invention in any way. Moreover, it is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A self-cleaning valve comprising:
a valve body defining an internal cavity and having a first end, a second end, a perimeter wall extending between the first end and a second end, an inlet fluidly communicating with the internal cavity, an outlet fluidly communicating with the internal cavity and a stem bore fluidly communicating with the internal cavity;
a valve stem having a first end and second end and operable for linear movement between a first open position and a second closed position, the valve stem received in the stem bore, the first end of the valve stem having a plug, the plug adapted to seal the inlet of the valve body when in the second closed position.

2. The self-cleaning valve of claim 1 wherein the stem bore is located at the first end of the valve body and the inlet is located at the second end of the valve body and the stem bore and the inlet are located on the longitudinal axis of the valve.

3. The self-cleaning valve of claim 1 wherein the valve stem is threaded and cooperates with a threaded gland follower, the threaded gland follower fixed to the first end of the valve body and wherein when the valve stem is rotated relative to the valve body the valve stem is linearly translated relative to the valve body thereby moving the valve stem from the first open position to the second closed position.

4. The self-cleaning valve of claim 1 wherein the stem bore is sealed by a bonnet, the bonnet having a bore aligned with the stem bore and receiving the valve stem in fluid sealing engagement, the bonnet fixed to the first end of the valve body.

5. The self-cleaning valve of claim 1 wherein the bonnet further includes a stem riser having a bore, the bore aligning with the stem bore.

6. The self-cleaning valve of claim 5 wherein the bore of the stem riser is threaded to cooperate with the valve stem.

7. The self-cleaning valve of claim 1 wherein the outlet is located in a perimeter wall of the valve body.

8. The self-cleaning valve of claim 1 wherein the plug is generally frustoconically shaped.

9. The self-cleaning valve of claim 1 wherein the plug is generally bulbously shaped.

10. The self-cleaning valve of claim 1 wherein the second end of the valve stem further comprises a hand wheel.

11. The self-cleaning valve of claim 1 wherein the valve stem has a first section having a first diameter, a second section having a second diameter and a shoulder between the first section and the second section and wherein the shoulder abuts an internal surface of the internal cavity of the valve body in fluid sealing engagement, the internal surface of the internal cavity of the valve body being adjacent the valve bore.

12. The self-cleaning valve of claim 1 wherein the valve body further includes an internal diffuser mechanism and the inlet of the valve body is located at a second end of the internal diffuser mechanism, the internal diffuser mechanism having a bore at a first end which aligns with the stem bore in order to operably receive the valve stem, the internal diffuser mechanism having at least one radially oriented outlet that fluidly communicates with the outlet of the valve body.
